(19) United States
(12) Patent Application Publication
(10) Pub. No.: US 2010/0207942 A1
(43) Pub. Date: Aug. 19, 2010

(54) APPARATUS FOR 3-D FREE HAND RECONSTRUCTION

(75) Inventor: Shuang Ren Zhao, North York (CA)

Correspondence Address: MARSH, FISCHMANN & BREYFOGLE LLP, 8055 East Tufts Avenue, Suite 450, Denver, CO, 80237, US

(73) Assignee: EIGEN, INC., GRASS VALLEY, CA (US)

(21) Appl. No.: 12/695,822

(22) Filed: Jan. 28, 2010

Related U.S. Application Data
(60) Provisional application No. 61/147,932, filed on Jan. 28, 2009.

(51) Int. Cl. G06T 17/00

(52) U.S. Cl. 345/424

(57) ABSTRACT

One object of the present disclosure is to provide an interpolation method for reconstructing an imaged object with the image edge as sharp as possible and the image itself as smooth as possible. An The EM (Expectation Maximization) image reconstruction is provided that suitable for freehand ultrasound systems.

### CROSS REFERENCE TO RELATED APPLICATION

This application claims the benefit of the filing date of U.S. Provisional Application No. 61/147,932 entitled: “Apparatus for 3-D Free Hand Reconstruction” and having a filing date of Jan. 28, 2009, the entire contents of which are incorporated by reference

### FIELD

This application presents a new method for performing the image interpolation/reconstruction from freehand ultrasound data.

### BACKGROUND

Medical imaging is utilized to provide images of internal patient structure for diagnostic purposes as well as for interventional procedures. Often, it is desirable to utilize multiple two-dimensional (i.e. 2-D) images to generate (e.g., reconstruct) a three-dimensional (i.e., 3-D) image of an internal structure of interest.

2-D image to 3-D image reconstruction has been used for a number of image acquisition modalities (e.g., ultrasound) and image based/guided procedures. These images may be acquired as a number of parallel 2-D image slices/planes or rotational slices/planes, which are then combined together to reconstruct a 3-D image volume. Generally, the movement of the imaging device has to be constrained such that only a single degree of freedom is allowed (e.g., rotational movement. This single degree of freedom may be rotation of the imaging device or a linear motion of the imaging device.

For the rotary scanning, if the angle between two scans is small enough, the object will be fully scanned without any holes. This means at each voxel there exist a measured position. For the freehand scanning, normally there are holes in the scanned data. This means there some voxel in the space where little or no scanned data is available. The difficulty of the interpolation for the freehand scanning compared to rotary scanning is that the data is required to be filled to the above described holes.

When an object is free hand scanned using an ultrasound image system, a group of values and positions are measured, which are the input data of this ultrasound system. Then interpolation methods are utilized to reconstruct the original object from this input data. Normally this input data is noisy, and the positions of the measurement are sparse or irregularly distributed in the space. There are holes (without data to fill all grid points in the space) on the freehand ultrasound data.

### SUMMARY

One object of the present disclosure is to provide an interpolation method for reconstructing an imaged object with the image edge as sharp as possible and the image itself as smooth as possible.

The EM (Expectation Maximization) image reconstruction is suitable for freehand and rotary ultrasound system. The EM method recovers the image based on the statistical model. It does not only interpolate the measured ultrasound data but also reduce the noises in the reconstruction process. The EM method reconstructs the image iteratively. In a loop of the iteration, each voxel of the image is updated from two images. The first is an image created directly from the input ultrasound data. The second is the filtered image of the output from the prior loop of the iteration. The filter in the EM method utilizes the neighbor points in a 3*3*3 cube in 3D situation. This kind filter is referred the cubic filter. In this invention the cubic filter in the EM method is replaced as anisotropic diffusion filter. The diffusion filter can further reduce the speckle noises and keep the image edge information simultaneously. It is remarkable the diffusion filter used here is not just a post-filter. It is used inside the loop of the iteration and hence is a component of modified EM method. The quality of reconstructed image is controlled through the combination of the two goals, (1) the smoothness of the image; (2) the sharpness of the image edges. These two goals are further controlled through the simulation which optimized the error functions. Here the error is the difference between the reconstructed image and the original object. Two error functions (A) the absolute error and (B) the square error are combined together. There are two parameters in this invention which are optimized to the combination of square error and absolute error in the simulation. One parameter is used for the EM method itself and the other parameter is used in the anisotropic diffusion filter. The algorithm is speed up with the technique of compute unified device architecture (CUDA) and graphics processing unit (GPU). The algorithm in this invention is tested with simulated and measured freehand 2D frame images.

Since the measured ultrasound data is noisy, the interpolation method is required also to recover the image and reduce the noise simultaneously. There are 3 major kinds of interpolation methods available, Voxel-based method, Pixel-Based Methods and Function-Based methods.

Voxel-Base Methods (VBM) traverse each voxel in the target voxel grid and gather information from the input 2D ultrasound data. In different algorithms, one or several pixels may contribute to the value of each voxel. Pixel-Based Methods (PBM) each pixel in the input image and assign the pixel value to one or several voxels. A PBM may consist of two steps: a distribution Step (DS) and a hole-filling step (HFS). In the DS, the input pixels are traversed and the pixel value applied to one or several voxels, often stored together with a weight values. In the HFS, the voxels are traversed and empty voxels are being filled. Function-Based Methods (FBM) provide methods where goal functions are utilized. The coefficients and parameters of the algorithms are optimized with the goal function. There two major FBMs. In a first, splane functions are utilized for the interpolation. The coefficients of the interpolation are calculated through the balance of the errors of the reconstructed image to the measured ultrasound data and the smoothness of the reconstructed image. Group linear equations are solved in this algorithm. In order to reduce the size of the linear equations, the 3D space is divided to sub-regions. The linear equations are solved on the sub-region with an additional boundary place. The second is the EM (Expectation Maximization) In this algorithm, Bayesian framework estimates a function for the tissue by statistical methods. The algorithm in reference can be summary as an iterative filter. Inside the loop of the iteration, the updated image voxel is obtained through two parts, the first is the measured ultrasound data (if it exists inside this voxel), and the second is the average of the image voxel and all its surrounding image voxels. This method achieved good results of reconstruction. A diffusion technique of the EM method may be utilized for rotary scanning ultrasound. This requires that the measured data is not sparse (without holes) which is only suitable to the rotary scanning instead of the freehand scanning.

The method in this invention is an interpolation method for B-scan of the freehand ultrasound. It is a modified EM method replacing the cubic average filter to the anisotropic diffusion filter. The presented invention is aimed at providing a 3D image interpolation/reconstruction algorithm for freehand ultrasound B-scan data which is measured at a group of random distributed planes. This measured ultrasound data is noisy and sparse (with holes) in 3D space. The algorithm reconstructs the image with sharp image edges and the smoothes the image simultaneously.

The algorithm presented in this disclosure is a modified EM algorithm. In this disclosure the anisotropic diffusion filter is utilized instead of the cubic filter. An anisotropic diffusion filter adds a new parameter to the algorithm which can be optimized in order to further reduce the errors. Here the error means the difference between the reconstructed image from simulated freehand-scanning ultrasound data and the original object to create the ultrasound data.

The algorithm in this presented disclosure is an iterative algorithm. Inside the loop of the iteration the updated image is calculated through two parts of the images. The first is the image directly obtained from the acquired data. The second is the output image from the prior loop of the iteration. The second image is filtered through an anisotropic diffusion filter.

The presented algorithm has two parameters, the first is used to balance two kinds of image described in the last paragraph; the second is used to adjust the strength of the anisotropic diffusion filter. The present disclosure utilizes an additional parameter in comparison to prior techniques. The additional parameter enhance the optimization process. The two parameters are optimized with smallest error between the reconstructed image from the simulated freehand ultrasound data and the original object to create the ultrasound data. The error is defined as a combination of the absolute error and the square error. Combining two kind errors together can better balance the sharpness of the image edge and the smoothness of the image itself. The optimized parameters are utilized in the reconstruction from measured freehand-scanning ultrasound data.

Since the iteration with the anisotropic diffusion filter is very time consuming. The GPU CULD technique is utilized to speed the algorithm.

### BRIEF DESCRIPTION OF THE DRAWINGS

FIG. 1A shows a freehand ultrasound tracker system.

FIG. 1B shows image planes obtained by the freehand ultrasound tracker.

FIG. 2 shows the coordinates of the tracker system.

FIG. 3 illustrates the input geometry of a 3D ultrasound system.

FIG. 4 illustrates a first step in generating the reconstructed image, which is done before the iteration process. The image is at a 3D 200*200*200 grid. The center plane is shown.

FIG. 5 illustrates the working flow for the 3D Free hand reconstruction algorithm. The position of probe and the ultrasound frame image of patient are measured in the compound of the free hand data acquisition is shown in FIG. 6. The position data and ultrasound data is sent to the 3D freehand reconstruction compound which is shown in FIG. 8. The output is the reconstructed image.

FIG. 6 illustrates the Free Hand Data Acquisition. The position and signal compound is shown in FIG. 7.

FIG. 7 illustrates the working flow for Position & Signal.

FIG. 8 illustrates the work flow for 3D Freehand Reconstruction. The initialization procedure compound is shown in FIG. 9. The diffusion procedure is shown in FIG. 10.

FIG. 9 illustrates the work flow for initialization procedure.

FIG. 10 illustrates the work flow for diffusion procedure. This shows the diffusion procedure working in a CPU.

FIG. 11 illustrates the working flow for the optimization of the parameters. The compound of Synthetic Simulation is shown in FIG. 12.

FIG. 12 illustrates the Synthetic Simulation. The data acquisition compound is shown in FIG. 13. The 3d Freehand reconstruction compound is shown in FIG. 8.

FIG. 13 illustrates the working flow for data acquisition. The compound position generate is shown is in FIG. 14. The signal generate are in FIG. 16.

FIG. 14 illustrates the work flow for position Generate. The compound calculate offset d is shown in FIG. 15.

FIG. 15 illustrates Offset Calculate (d)

FIG. 16 illustrates the Signal Generate.

FIG. 17 illustrates the principle of diffusion procedure working with a GPU.

FIG. 18 illustrates the working flow for the optimization of the parameters in a GPU.

FIG. 19 illustrates the reconstructed 3D image of the presented invention. The center plane is shown.

FIG. 20 illustrates the corresponding profiles of FIG. 19.

### DETAILED DESCRIPTION OF THE INVENTION

Reference will now be made to the accompanying drawings, which assist in illustrating the various pertinent features of the various novel aspects of the present disclosure. Although the invention is described primarily with respect to an ultrasound imaging embodiment, aspects of the invention may be applicable to a broad range of imaging modalities, including MRI, CT, and PET, which are applicable to organs and/or internal body parts of humans and animals. In this regard, the following description is presented for purposes of illustration and description. Furthermore, the description is not intended to limit the invention to the form disclosed herein. Consequently, variations and modifications commensurate with the following teachings, and skill and knowledge of the relevant art, are within the scope of the present invention.

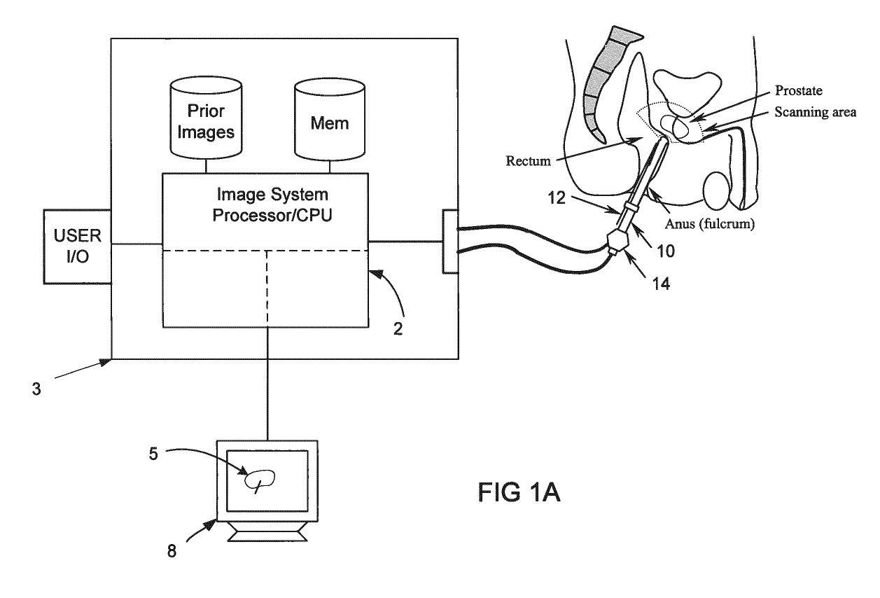

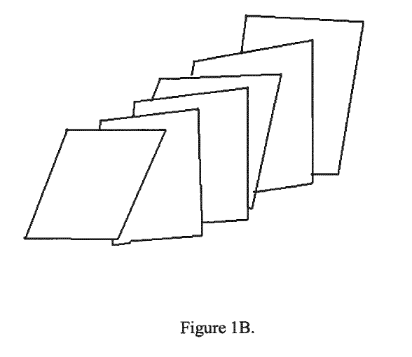

An exemplary embodiment of the invention will be described in relation to performing prostate scanning using freehand transrectal ultrasound (TRUS). As shown in FIG. 1A. The ultrasound probe 10 has a biopsy needle assembly 12 may be attached to its shaft inserted into the rectum from the patient's anus. The probe 10 may be an end-fire transducer that has a scanning area of a fan shape emanating from the front end of the probe (shown as a dotted outline). The probe handle is hand held for freehand scanning. In any case, the probe includes a set of position sensors 14. These position sensors 14 are connected to the computer 2 of the imaging system 3 via an analog to digital converter. Hence, the computer 2 has real-time information of the location and orientation of the probe 10 in reference to a coordinate system.

With the dimensions of the probe 10 and needle assembly 12 taken into the calculations, the 3D position of the needle tip and its orientation is known. The ultrasound probe 10 sends signal to the ultrasound system 3, which may be connected to the same computer (e.g., via a video image grabber) as the output of the position sensors 14. In the present embodiment, this computer is integrated into the imaging system 3. The computer 2 therefore has real-time 2D and/or 3D images of the scanning area in memory. The image coordinate system and the robotic arm coordinate system are unified by a transformation. Using the acquired 2D images, a prostate surface 5 (e.g., 3D model of the organ) and biopsy needle are simulated and displayed on a display screen 8. A biopsy needle may also be modeled on the display, which has a coordinate system so the doctor has the knowledge of the exact locations of the needle and the prostate.

The computer system runs application software and computer programs which can be used to control the system components, provide user interface, and provide the features of the imaging system. The software may be originally provided on computer-readable media, such as compact disks (CDs), magnetic tape, or other mass storage medium. Alternatively, the software may be downloaded from electronic links such as a host or vendor website. The software is installed onto the computer system hard drive and/or electronic memory, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having computer-readable program code embodied therein. The software contains one or more programming modules, subroutines, computer links, and compilations of executable code, which perform the functions of the imaging system. The user interacts with the software via keyboard, mouse, voice recognition, and other user-interface devices (e.g., user I/O devices) connected to the computer system. Aspects of the present invention may be embodied as software and/or hardware.

I. Creating the 3D Freehand Simulated Ultrasound Data

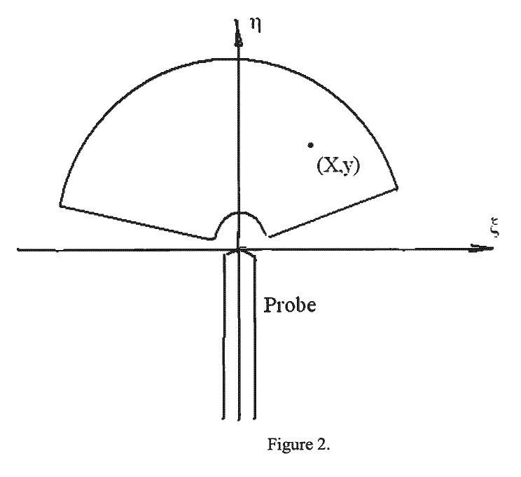

The free hand ultrasound scanning planes are shown in FIG. 1B. As shown, the free hand ultrasound scanning planes are not parallel. That is, the direction of the planes is random. One of the scanned planes can be shown in the ultrasound machine as a 2D image frame. The 2D image frame is shown in FIG. 2 which provide coordinates of the image/video frame. The coordinates are X=(ξ, η, 0), the video signal is described as y. The whole output are position and signal (X, y).

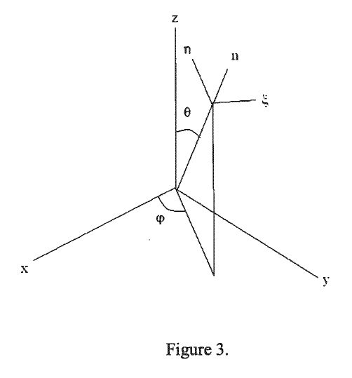

The measured signal yᵢ and the position in video frame coordinates are Xᵢ^{Video}=(X₁ᵢ^{video}, X₁ᵢ^{video}, 0). The frame plane position is measured by the tracker system. The position (angles θ, φ) of the tracker probe is measured on the tracker coordinates as seen in FIG. 3. The tracker coordinates may be fixed to the earth.

There are few coordinates: (1) The volume coordinates X, which is the coordinates to show 3D reconstructed image; (2) Tracker coordinates Xₜᵣ which is show in FIG. 2 (in the present arrangement, the tracker coordinates are fixed to the earth and the volume coordinate has a fixed rotation angles with the tracker coordinates); (3) ultrasound sensor coordinates; and (4) The video coordinates Xᵥᵢ which is the place to measure the ultrasound frames. The coordinates can be transfer as X^{volume}=^{vo}TₜᵣX^{tracker}, X^{tracker}=^{tr}TₛₑX^{sensor}, X^{sensor}=^{se}TᵥᵢX^{video}. Here ^{vo}Tₜᵣ is 4×4 tracker to volume coordinate transform. Which is related a fix angle of the tracker θ₀, φ₀, ρ₀. Here ρ₀ is the self-rotation angle of the ultrasound censor probe. ^{se}Tᵥᵢ is 4×4 video to ultrasound sensor coordinate transform. It is related the angles θ, φ, ρ here θ, φ is defined in FIG. 3. Here ρ is the self-rotation angle of the ultrasound censor probe. ^{se}Tᵥᵢ is 4×4 video coordinate to sensor coordinate transform. ^{se}Tᵥᵢ is related to the video pixel to mille-miter scaling coefficient, the displacement from video origin to the ultrasound censor source origin.

Assume it is known that the original object of the ultrasound image is ƒ(X). Examples of ƒ(X) are a cube or a sphere. Here X is on 3D space. The task of this section is to create a set of ultrasound measured point Xᵢ and to give out the simulated output of the values of ultrasound signal Yᵢ according to the original object ƒ(X) and the noise model. Here Xᵢ=(xᵢ¹, xᵢ², xᵢ³) is the point of the ultrasound measured point, xᵢ¹, xᵢ² and xᵢ³ are 3D coordinates. i=0, 1, 2, 3 . . . I−1 is the index of the measured points. I is the size of measured points. Xᵢ is on a set of planes which simulated the 2D ultrasound B-scans. Yᵢ is used to express a measured values of the ultrasound at the point Xᵢ. If ƒ(X) is known only on the grids, ƒ(Xᵢ) can be obtained from interpolation.

η(Xᵢ)=Interpolation η(X) (1)

The Interpolation can be the nearest interpolation which is defined as the following,

$$f ( {X}_{i} ) = \frac{{\sum }_{i = 1}^{8} \frac{1}{{r}_{i}} f ( {X}^{( i )} )}{{\sum }_{i = 1}^{8} \frac{1}{{r}_{i}}} \qquad ( 2 )$$

Here rᵢ is the distance from the point Xᵢ to the 8 nearest neighbor points on the regular grid (X⁽¹⁾, X⁽²⁾, . . . , X⁽⁸⁾). Normally ƒ(X) is taken as an ideal ship, for example a sphere or a cube. In this situation the values ƒ(X) is known exactly everywhere in the 3D space include ƒ(Xᵢ). The above interpolation can be avoided. In the following section we assume the object ƒ(X) is a cube.

Assume the object function ƒ(X) has zero value outside of a enough large radio R_{L}. The measured points Xᵢ are on a set of planes. The plane equation are written as

n₁x¹+n₂x²+n₃x³=r (3)

Here \hat{n}=(n₁, n₂, n₃) is the perpendicular normal vector of the plane and

n₁=sin θ cos φ, n₂=sin θ sin φ, n₃=cos θ (4)

where θ is the angle between the normal vector \hat{n} and the coordinate x³, φ is the angle between the projection of the normal vector \hat{n} on the (x ¹, x²) plane and the coordinate x¹, r is the distance from the plane to the original point in the 3D space. Assume there are 2D rectangle coordinates (ξ, η) on the plane which is expressed by equation (3) above.

In the practical situation the measured points are on a fan region with a polar coordinates. However considering the only requirement is that the measurement are distribute on a grid without holes on it, hence we use the rectangle coordinates in 2D plane for the simplicity. The direction of the coordinates (ξ, η) are defined as following,

$$\begin{matrix}{η}_{1} = sin ( θ - \frac{π}{2} ) cos ϕ = - cos ( θ ) cos ϕ , \\ {η}_{2} = sin ( θ - \frac{π}{2} ) sin ϕ = - cos ( θ ) sin ϕ \\ {η}_{3} = cos ( θ - \frac{π}{2} ) = sin ( θ ) & ( 5 ) \\ \hat{ξ} = \hat{η} \times \hat{n} & ( 6 )\end{matrix}$$

The direction of the vectors \hat{ξ}, \hat{η}, \hat{n} can be seen in FIG. 3. Assume that

$$\begin{matrix}( - {R}_{L} < ξ < {R}_{L} , - {R}_{L} < η < {R}_{L} ) \\ where & ( 7 ) \\ {R}_{L} = \sqrt{3} R \\ and & ( 8 ) \\ R = \frac{N - 1}{2} & ( 9 )\end{matrix}$$

All measurement points X are on the plane (ξ, η). Assume d is the projection of vector. X on the plane (ξ, η) which is known on the measurement.

d=ξ\hat{ξ}+η\hat{η} (10)

The coordinate X on the 3D space can be found

X=X₀+d (11)

where X₀=r\hat{n}, is the original point of the coordinates (ξ, η). Here X=(x₁, x₂, x₃). The above equation can be rewritten as components,

x₁=rn₁+ξξ₁+ηη₁

x₂=rn₂+ξξ₂+ηη₂

x₃=rn₃+ξξ₁+ηη₃ (12)

According to above knowledge, the simulated ultrasound data can be created as following sub-section.

The creation of ultrasound freehand scanning data is summarized as following,

Step 1. Create a set of random values X₀=(x₀¹, x₀², x₀³) satisfy Gauss distribution.

$$p ( {x}_{0}^{1} , {x}_{0}^{2} , {x}_{0}^{3} ) = Z exp ( - \frac{{( {x}_{0}^{1} )}^{2} + {( {x}_{0}^{2} )}^{2} + {( {x}_{0}^{3} )}^{2}}{{σ}^{2}} ) \qquad ( 13 )$$

where p(x₀¹, x₀², x₀³) is probability distribution function, Z is the normalization factor, σ is taken for example as 0.3R. Here 0.3 is chosen through experiment. If this value is taken too big, most of the points of x₀¹, x₀², x₀³ will be distributed closing to the boundary of 3D space. If it is taken too small most of the points oƒ(x₀¹, x₀², x₀³) will be distributed closing to the center of the 3D space.

Step 2. The measurement plane is calculated through

$$\begin{matrix}r = \sqrt{{( {x}_{0}^{1} )}^{2} + {( {x}_{0}^{2} )}^{2} + {( {x}_{0}^{3} )}^{2}} \\ {n}_{1} = \frac{{x}_{0}^{1}}{\sqrt{{( {x}_{0}^{1} )}^{2} + {( {x}_{0}^{2} )}^{2} + {( {x}_{0}^{3} )}^{2}}} \\ {n}_{2} = \frac{{x}_{0}^{2}}{\sqrt{{( {x}_{0}^{1} )}^{2} + {( {x}_{0}^{2} )}^{2} + {( {x}_{0}^{3} )}^{2}}} & ( 14 ) \\ {n}_{3} = \frac{{x}_{0}^{3}}{\sqrt{{( {x}_{0}^{1} )}^{2} + {( {x}_{0}^{2} )}^{2} + {( {x}_{0}^{3} )}^{2}}} & ( 15 )\end{matrix}$$

Step 3. Calculate the (θ, φ) through the above directions.

θ=arccos(n₃)

φ=arctan₂(n₂,n₁) (16)

where arctan₂ is the atan 2 function defined in Matlab or the c++ head file Math.h.

Step 4. calculate \hat{ξ}, \hat{η} according to the Eq. (5) and (6).

Step 5. calculate measured points Xᵢ=(xᵢ¹, xᵢ², xᵢ³) from Eq. (12). Take out all the points outside the region [—R, R]³.

Step 6. Assume the original function ƒ(X) is a cube.

$$f ( {X}_{i} ) = \{ \begin{matrix}const \vert {x}_{i}^{1} \vert < R , \vert {x}_{i}^{2} \vert < R , \vert {x}_{i}^{3} \vert < R \\ 0\end{matrix} \} \qquad ( 17 )$$

The constant const can be taken as, for example, const=10.

Step 4. Add the object related random noise to the original function as following

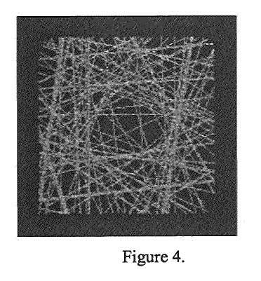

Yᵢ=ƒ(Xᵢ)+ƒ(Xᵢ)*Noise (18)

where the variable Noise is a random variable satisfies uniform distribution in the region [−0.5, 0.5]. Here 0.5 is taken so that the noise Noise and signal ƒ(Xᵢ) has the same wave width. Put the Yᵢ to the coordinates Xᵢ in the 3D volume image space, it can be shown in FIG. 4 where the profile of image Uₚ^{ML} at the center plane p³=100. Here the size of image is 200×200×200. This Figure also can be seen as that we have directly put value Yᵢ to the coordinates Xᵢ in the 3D volume image space.

II. The EM Method with the Cubic Filter

The EM method with the cubic filter is an iterative an algorithm. The updated image ⁿ⁺¹Uₚ is obtained from a combination of two parts. The first is the first step reconstructed image before any iteration Uₚ^{ML} Uₚ^{ML} is obtained directly from free hand ultrasound input data. The second is the neighborhood average ⁿŪₚ of the image from the last iteration,

ⁿ⁺¹Uₚ=(1−kₚ)Uₚ^{ML}+kₚⁿŪₚ (19)

where ⁿ⁺¹Uₚ is the output image of Uₚ in (n+1) times of the loop of the iteration. Uₚ^{ML} is defined as

$${U}_{p}^{ML} = \{ \begin{matrix}{\sum }_{i} {Y}_{i} η ( p , {X}_{i} ) / {\sum }_{i} η ( p , {X}_{i} ) & ∃ {X}_{i} ∈ Ω \\ 0 & ∀ {X}_{i} ∉ Ω\end{matrix} \qquad ( 20 )$$

where Ω=[p¹−Δ, p¹+Δ][p²−Δ, p²+Δ][p³−Δ, p³+Δ], X₁ is the i-th position of ultrasound measurement. Yᵢ is i-th measured value of ultrasound measurement. ∃X; means there exist a Xᵢ. ∀Xᵢ means for all Xᵢ p=(p¹, p², p³) is the position of ultrasound image voxel. Δ is the space between two pixels. In this article Δ=1. p¹, p², p³ are discrete rectangle coordinates which are integers of 0, 2, . . . N−1.

$$\begin{matrix}η ( p , {X}_{i} ) = h ( p - {X}_{i} ) & ( 21 ) \\ h ( X ) = \{ \begin{matrix}{\prod }_{k = 1}^{3} ( 1 - \vert {x}^{k} \vert / Δ ) & X ∈ δ \\ 0 & otherwise\end{matrix} & ( 22 )\end{matrix}$$

Here x^{k} is x¹, x² or x³. δ=[−Δ, Δ]³. In this simulation Δ is taken as 1. kₚ in Eq. (19) is defined as following,

$$\begin{matrix}{k}_{p} = \frac{1}{1 + {A}_{p}} \\ where & ( 23 ) \\ {A}_{p} = \{ \begin{matrix}K {\sum }_{i} η ( p , {X}_{i} ) & ∃ {X}_{i} ∈ Ω \\ 0 & ∀ {X}_{i} ∉ Ω\end{matrix} & ( 24 )\end{matrix}$$

where K can be a constant parameter. ∃Xᵢ means there exist a Xᵢ. ∀Xᵢ means for all Xᵢ. In a prior method, K is taken as a variable parameter. It is dependent to σ(X)

$$K = \frac{{K}_{c}}{{σ}^{2} ( X )} \qquad ( 25 )$$

Here σ(X) is variance of measured data. However this value cannot be obtained to arbitrary small point X. It is defined on a small region close to X. K_{c} is a constant parameter. The average in Eq. (19) is defined as

$${{\overline{U}}_{p} = \frac{1}{27} [ {\sum }_{a = - 1 , b = - 1 , c = - 1}^{1 , 1 , 1} {U}_{i - a , j - b , k - c )} ]}^{ } \qquad ( 26 ) )$$

where p=(i, j, k). The average can be seen as a 27 element cube filter.

III. The Modified EM Method with the Diffusion Filter

The method described in last paragraph is referred to as the EM method with cubic filter. In this invention a new method is proposed in which the cubic filter Ūₚ is replaced as the diffusion filter D Uₚ. The presented method in is referred as the modified EM method with the diffusion filter. The iteration algorithm of Eq. (19) is modified to as the following,

ⁿ⁺¹Uₚ=(1−kₚ)Uₚ^{ML}+kₚDⁿUₚ (27)

where ⁿ⁺¹Uₚ is (n+1) times iteration of Uₚ. The definition of kₚ and Uₚ^{ML} are same as in Eq. (19). kₚ is calculate from Eq. (23) and (24). It is noticed that in this invention K in the Eq. (24) is taken as an independent constant parameter K=const and it is not adapted to σ(X).

The anisotropic diffusion filter used here is defined as the following,

DU_{P}=U_{P}+tcΔUₚ (28)

where t is a constant and c is defined as

$$c ≡ g ( \frac{‖ ▽ {U}_{p} ‖}{m} ) \qquad ( 29 )$$

where m is a normalization factor. m is the max value of the original object (this value is not required very accuracy, it can be approximately evaluated).

m=max(ƒ(X)) (30)

where g(x) has two forms which are shown in the following

$$\begin{matrix}{g}_{1} ( x ) ≡ exp ( - {( x / {K}_{d} )}^{2} ) & ( 31 ) \\ {g}_{2} ( x ) ≡ \frac{1}{1 + {( x / {K}_{d} )}^{2}} & ( 32 )\end{matrix}$$

27 point neighborhood average can be replaced as 7 point neighborhood average:

$${\overline{U}}_{p} = {\overline{U}}_{( i , j )} = \frac{1}{7} ( \begin{matrix}{U}_{( i - 1 , j , k )} + {U}_{( i , j - 1 , k )} + {U}_{( i , j , k - 1 )} + \\ {U}_{( i , j , k )} + {U}_{( i + 1 , j , k )} + {U}_{( i , j + 1 , k )} + {U}_{( i , j , k + 1 )}\end{matrix} ) \qquad ( 33 )$$

The above formula can be rewritten as

$${\overline{U}}_{p} = {U}_{p} + \frac{1}{7} Δ {U}_{p} \qquad ( 34 )$$

where ΔUₚ is defined as following,

ΔUₚ=∇_{E}U+∇_{W}U+∇_{N}U+∇_{S}U+∇ᵤU+∇_{d}U (35)

where

∇_{W}U=U_{(i-1,j,k)}−U_{(i,j,k)}

∇_{E}U=U_{(i+1,j,k)}−U_{(i,j,k)}

∇_{S}U=U_{(i,j-1,k)}−U_{(i,j,k)}

∇_{N}U=U_{(i,j+1,k)}−U_{(i,j,k)}

∇_{d}U=U_{(i,j,k-1)}−U_{(i,j,k)}

∇ᵤU=U_{(i,j,k+1)}−U_{(i,j,k)} (36)

In Eq. (28) cΔUₚ is implemented as following,

$$\begin{matrix}c Δ {U}_{p} = {c}_{E} {∇}_{E} U + {c}_{W} {∇}_{W} U + {c}_{N} {∇}_{N} U + {c}_{S} {∇}_{S} U + {c}_{U} {∇}_{U} U + {c}_{D} {∇}_{D} U \\ where & ( 37 ) \\ {c}_{A} = g ( \frac{\vert {∇}_{A} U \vert}{m} ) A = E , W , N , S , U , D & ( 38 )\end{matrix}$$

K_{d} in the Eq. (32) is the diffusion constant. If K_{d}→∞, c=g(x)→1. The effect of diffusion is eliminated.

DUₚ=Uₚ+tΔUₚ (39)

Comparing Eq. (39) with Eq. (34), if t=1.0/7, K_{d}→∞, There is DUₚ→Ūₚ. Hence t can be chosen around 1/7. In general If t>1/7, it can reduce the number of iteration. However if it is too larger the quality of reconstruction will be reduced.

IV. Optimization of the Parameters

The parameters used in two algorithms are optimized according to the absolute errors and the square errors. Here the errors are differences between the reconstructed image and the original object. Define the absolute errors function,

$${Err}_{1} ( K , {K}_{d} ) = \frac{1}{{N}^{3}} {\sum }_{i = 0 , j = 0 , k = 0}^{N - 1 , N - 1 , N - 1} \vert {U}_{r} ( i , j , k ) - {U}_{o} ( i , j , k ) \vert \qquad ( 40 )$$

Define the square error function,

$${Err}_{2} ( K , {K}_{d} ) = \frac{1}{{N}^{3}} {\sum }_{i = 0 , j = 0 , k = 0}^{N - 1 , N - 1 , N - 1} {\vert {U}_{r} ( i , j , k ) - {U}_{o} ( i , j , k ) \vert}^{2} \qquad ( 41 )$$

where Uₒ(i, j, k)=ƒ(iΔ, jΔ, kΔ) is the original object on the rectangle coordinates, Uᵣ(i, j, k) is the reconstructed image. For This invention there are two parameters K Eq. (24), and K_{d} in Eq. (31) and (32) which are required to be optimized. The optimization can be written as

$$\begin{matrix}[ K , {K}_{d} ] = {arg}_{K , {K}_{d}} min ( Err ( K , {K}_{d} ) ) \\ where & ( 42 ) \\ Err = {qErr}_{1} + ( 1 - q ) {Err}_{2} q ∈ [ 0 , 1 ] & ( 43 )\end{matrix}$$

where q is a constant to balance the two errors Err₁ and Err₂. q=0.5 is used here.

V. The Working Flow of the Method

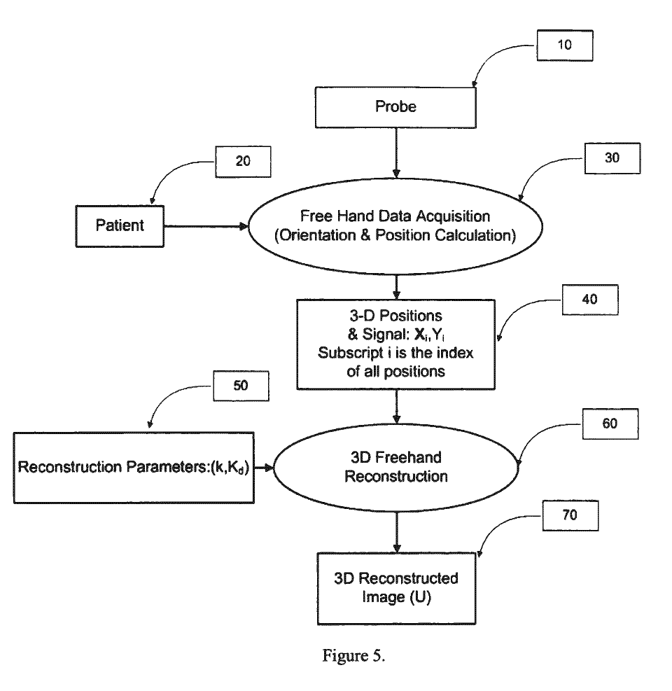

The free-hand reconstruction system. The working flow of the above described Freehand reconstruction system can be seen in FIG. 5 which graphically illustrates an exemplary 3D free hand reconstruction algorithm. Initially, an ultrasound probe 10 is used for ultrasound scanning a patient 20. The acquisition sub-system 30, which includes the tracker-sub system and ultrasound machine, acquires ultrasound data. The output 40 of the acquisition sub-system 30 is the position Xᵢ of signal Yᵢ. This output 40 is used as input of 3D freehand reconstruction sub-system 60. A reconstruction parameter(s) 50 is also the input of the freehand reconstruction sub-system 60. The output of the reconstruction is 3D volume image 70.

The Free-Hand Data Acquisition Sub-System.

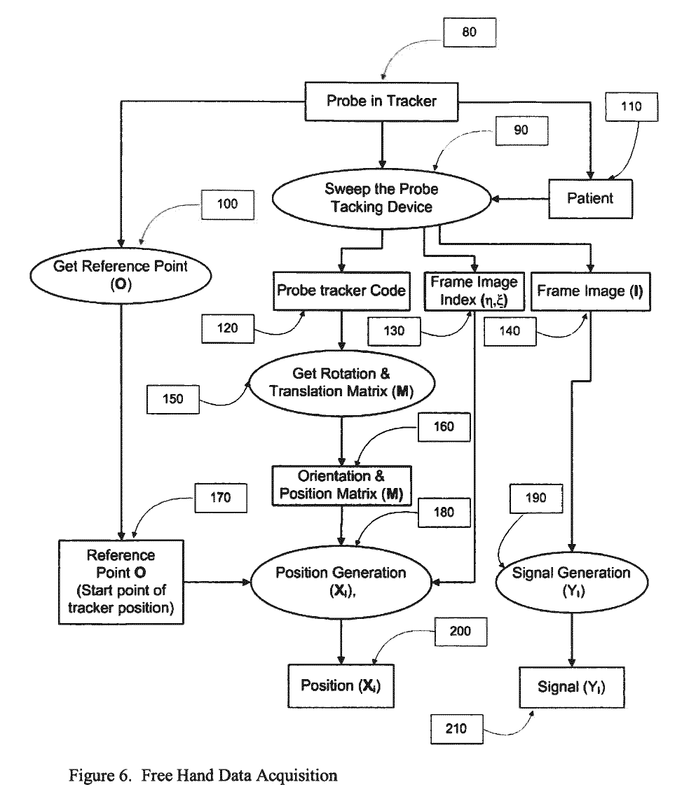

The freehand acquisition sub-system described in FIG. 6 is more fully set forth in FIG. 6. In use, a tracker probe 80 is used to scan an object of interest of a patient 110. This is generally done by sweeping 90 the probe over an area of interest. The tracker probe is coordinated to a reference point 100, which is also called a home point as it usually is the initial position of the tracker. The initial point is typically saved to memory 170.

After the scanning, the ultrasound signal generates an image 140. The tracker position (measured angle information) 120 is used to calculate transform matrix related to the rotation (angle ρ) and translation (displacement δ) matrix 150 that allows for aligning the image in a common frame of reference. This typically requires further calculating 160 the orientation matrix related to the tracker position (angles θ, φ)). Another output of is a frame image index. that offers the matrix from 3D volume space to the tracker home coordinates. The frame index matrix, reference point and orientation matrix form frame are utilized to generate a whole transform matrix. The point position in the frame image 130 combines the transform matrix to produce the point position in the 3D volume space X₁ 200. Another output of tracker probe is the measured ultrasound frame signal 140 which is utilized be the signal generation 190 to separate the frame signal to an individual signal related to a video point position Xᵢ. The output of ultrasound signal saved as yᵢ in 210.

Position Generation.

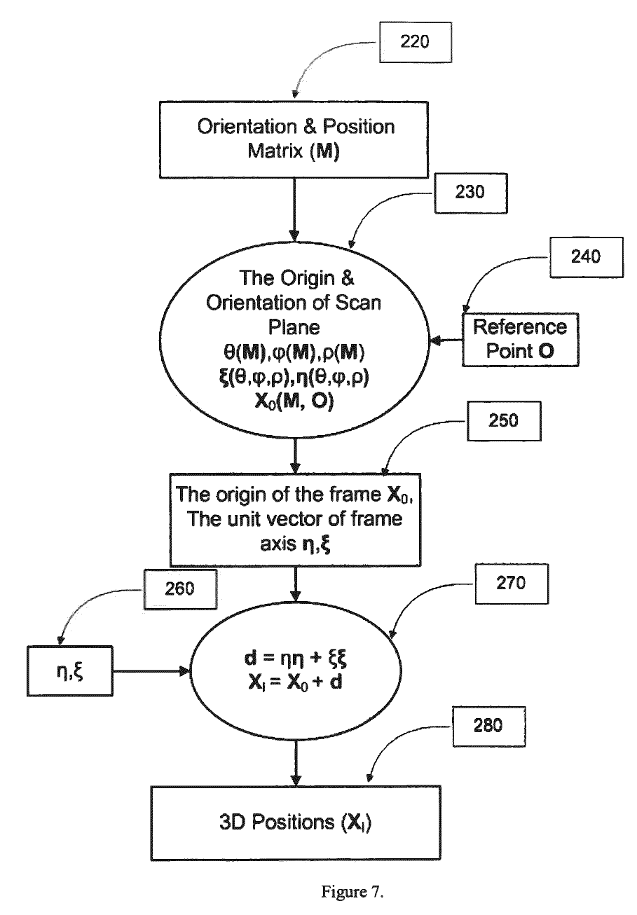

The details of the position generation sub-system 180 of FIG. 6 are described in FIG. 7.

FIG. 6 As shown, the sub-system receives the orientation matrix 220 of the ultrasound probe. The tracker's angle (θ, φ) can be calculated from this matrix. Combining this with the reference point O 240, the origin of the scan plane X₀ of the frame can be obtained 250. The position of the frame index 260 is the position of the frame which can be used in 270 to calculate the position in 3D volume space to generate an output 280.

### Freehand Reconstruction.

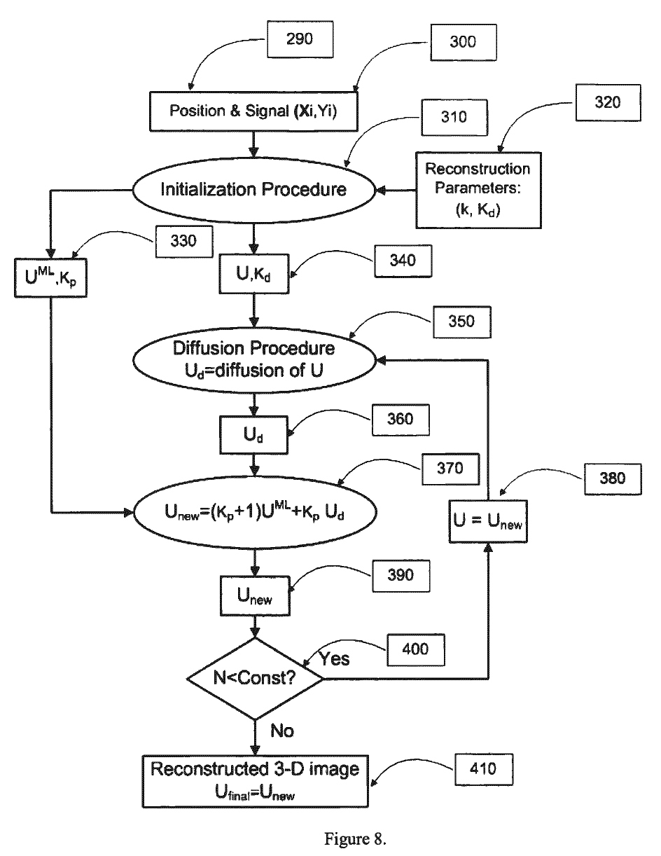

The freehand reconstruction sub-system 60 in FIG. 5 is described in FIG. 8. The input is the ultrasound signal and corresponding positions 300. An initialization procedure 310 create a variable space for reconstruction and also receives input of the initial reconstruction parameter 320. There are two outputs to 310. The first is 3D image Uₚ and parameter K_{d}. Uₚ is set up as 0. The second is the 3D images Uₚ^{ML} and kₚ. Uₚ^{ML} is obtained by putting all frame data available directly to the 3D space. Uₚ^{ML} 330 can be seen as the raw image before reconstruction. The 3D input image 340 is filtered here through a diffusion algorithm 350. The input of this diffusion procedure comes from the results of last iteration. The output of the diffusion procedure is 360 U_{d}. 370 adds two part of the 3D images together. The first part is the raw image Uₚ^{ML} 330. The second is the output 360 from the diffusion procedure. The weights of the two part are dependent on kₚ. This generates a compound output 390. If the iteration number N>constent in 400, the iteration is stopped and the 3D image output 410 output. Otherwise the 3D image is input the diffusion procedure for another iteration.

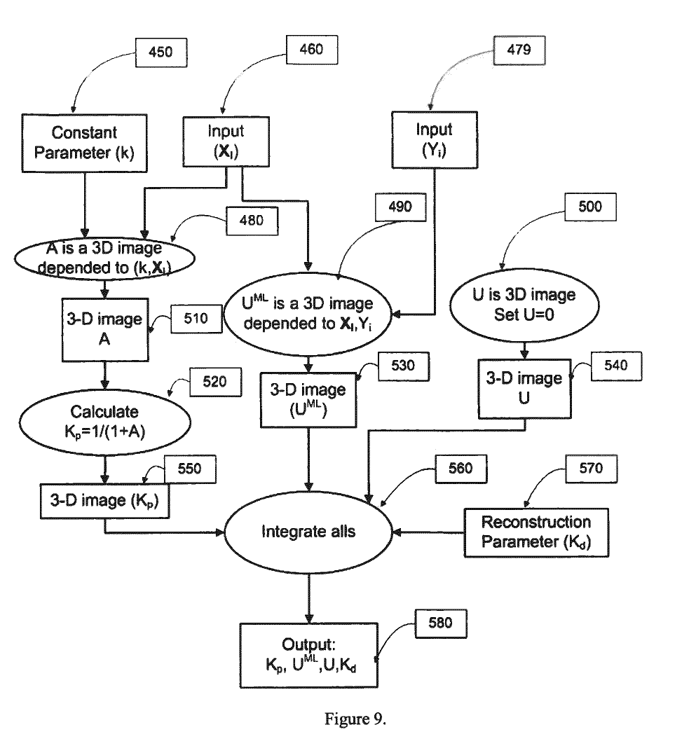

The initialization procedure 310 of FIG. 8 is described in FIG. 9. As noted above, the ultrasound frame position information Xᵢ and signal yᵢ is used to create the raw 3D image Uₚ^{ML}. The position information Xᵢ is also used to calculate the weight coefficient kₚ as illustrated in steps 480, 510 and 520. The weight coefficient is also dependent on an input constant 450. Memory space is created to save the 3D image 550, which is set up as 0. All the outputs 550, 530, 570 and 540 are combined to generate the outputs 580.

### Diffusion Procedure.

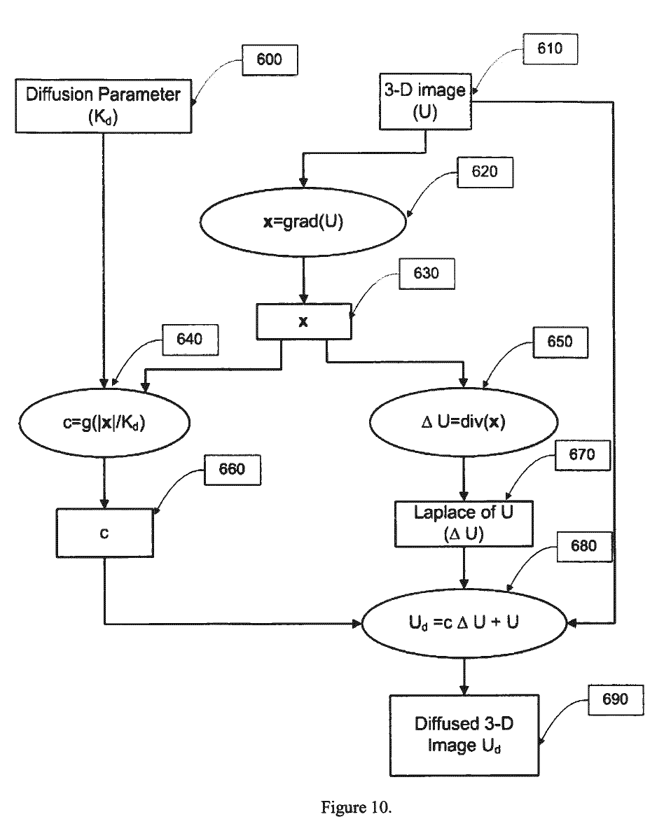

The diffusion procedure 350 of FIG. 8 is described in FIG. 10. The procedure calculates 620 the gradient of the image 610 to generate an output or image gradient 630. The procedure also calculates 640 the coefficient c 660 which is related to the gradient image and a threshold constant K_{d} 600. A gradient operator calculates 650 the divergence value of the image gradient 630. Since gradient operator that combines the divergence operator is a Laplace operator, a Laplace image 670 is obtained. The process adds the original image and the Laplace image in a compounding process 680 to generate a diffused 3D image 690.

### Optimization Procedures.

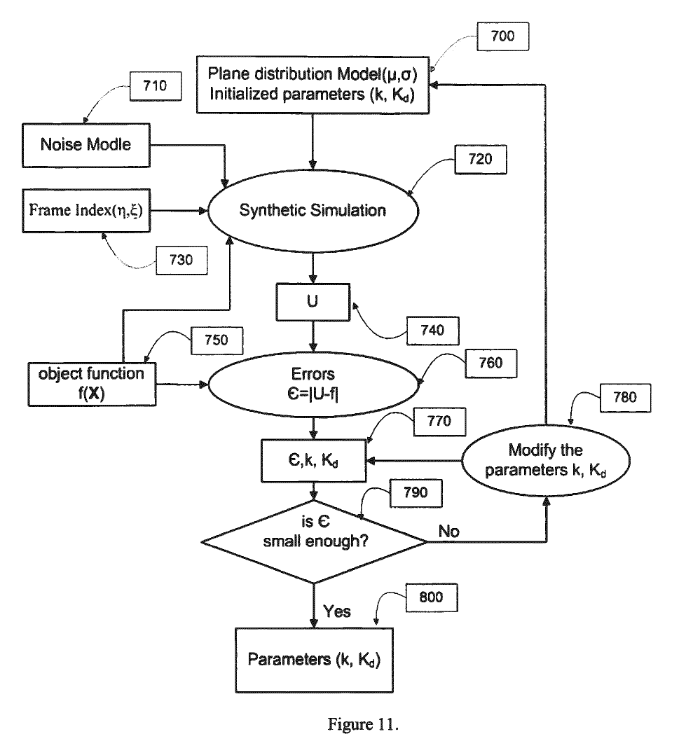

FIG. 11 describes an the optimization procedure. The initial value of the initialization parameters κ, K_{d} 700 typically require optimization. The parameters are utilized on a simulation procedure 720. The input of the simulation procedure are Noise Mode 710 and frame image index (η, ζ) and the 3D object image ƒ(X) 750. These input are used to create a simulated freehand ultrasound 2D frame images. The 2D frame images are reconstructed to produce a 3D volume image 740. The error function is calculated 760 in using the image 740 and the object function ƒ(X) 750. The error ε are absolute or square difference of two images. The errors c are compared 790. If it is small enough the parameter κ, K_{d} is sent to output 800. Otherwise κ, K_{d} is modified in 780 and send to input of the simulation procedure 700.

### The Simulation Procedure.

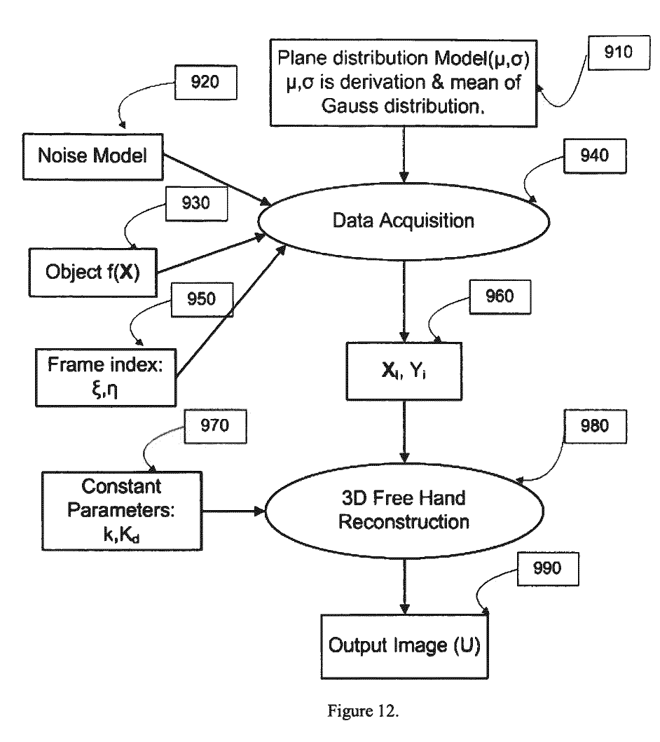

The simulation procedure compound 720 in FIG. 11 is described in FIG. 12. As shown, a data acquisition compound 940 receives inputs 910, 920, 930 and 950. Input 910 is the distribution model of the ultrasound scanning plane. The direction of the plane and the origin of the plane can be chosen as random variables. The Gauss distribution is used to generate all these parameters. The noise should be added to the ultrasound frame image. Input 950 describe the ultrasound image frames index (η, ζ). This index restricts a region, for example 480×640. The output 960 of the data acquisition compound 940 is the frame position Xᵢ and the corresponding ultrasound signal in that position yᵢ. This output(s) 960 is used as input of the reconstruction procedure 980. The reconstruction procedure 980 also uses the parameters κ, K_{d} to generate the 3d reconstructed image 990.

### The Data Acquisition Procedure.

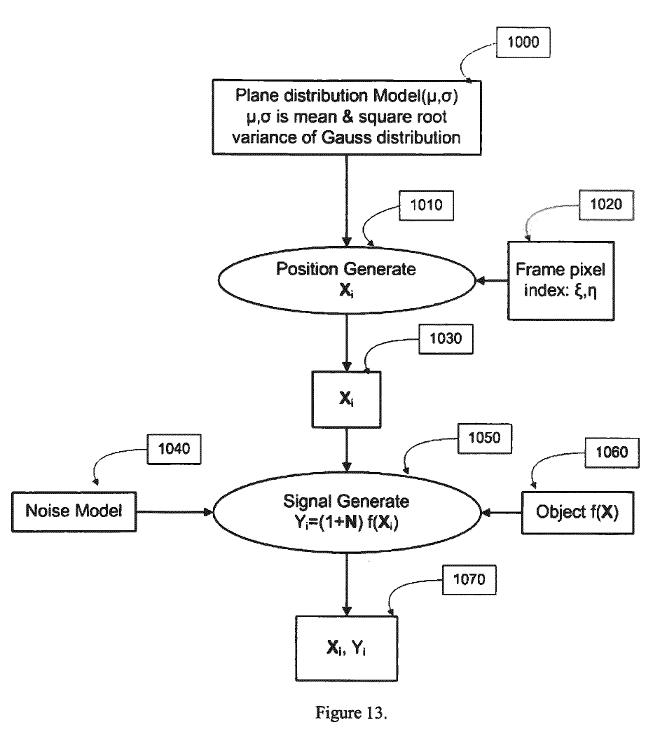

The data acquisition procedure of FIG. 12 is described in FIG. 13. The position of the ultrasound scanning plane can be decided through the unit vector of the plane and a point on the plane. This point P is randomly generated through the parameters of Gauss distribution μ, σ in 1000. The unit vector of the plane is taken as the direction from the origin point O to the generated point P. All the points inside a fan region (see FIG. 2) are taken and their position in the tracker coordinates are calculated, the output Xᵢ is output 1030. This position is used to calculate the corresponding object function value ƒ(Xᵢ). The ultrasound signal is produced through adding multiplication noises 1050 in conjunction with the input noises model 1040. The generates ultrasound signal yᵢ and its position Xᵢ 1070.

### The Position Generation Procedure.

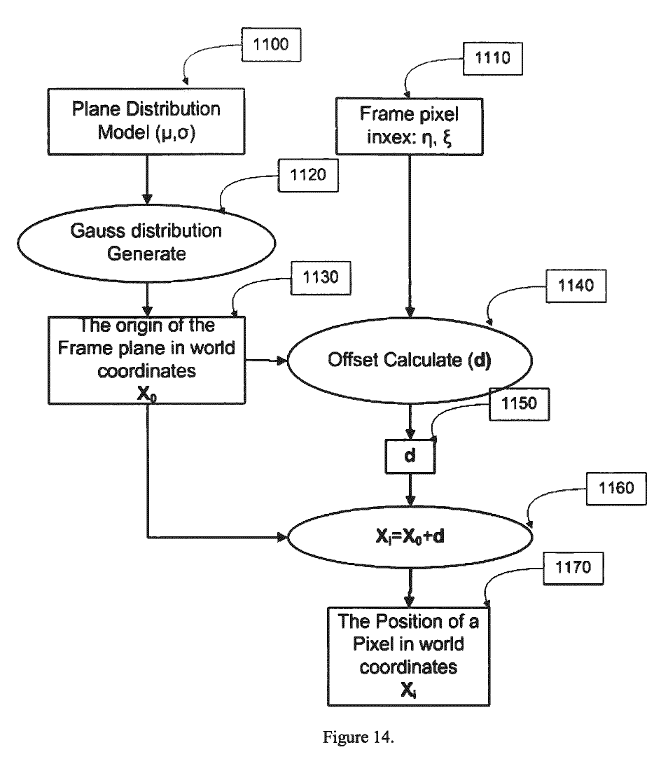

The position generation procedure of FIG. 13 is described in FIG. 14. The position of the frame origin Xₒ (This point is O in the frame coordinates 1120) is calculated through the Gauss distribution. An offset calculator calculates 1140 the offset vector d in the tracker coordinates from the frame index (η, ζ). This offset is utilized to calculate 1160 the position Xᵢ in the tracker coordinates corresponding to the frame index (η, ζ) and generate the position of a pixel in world coordinates 1170.

### The Calculation of the Offset.

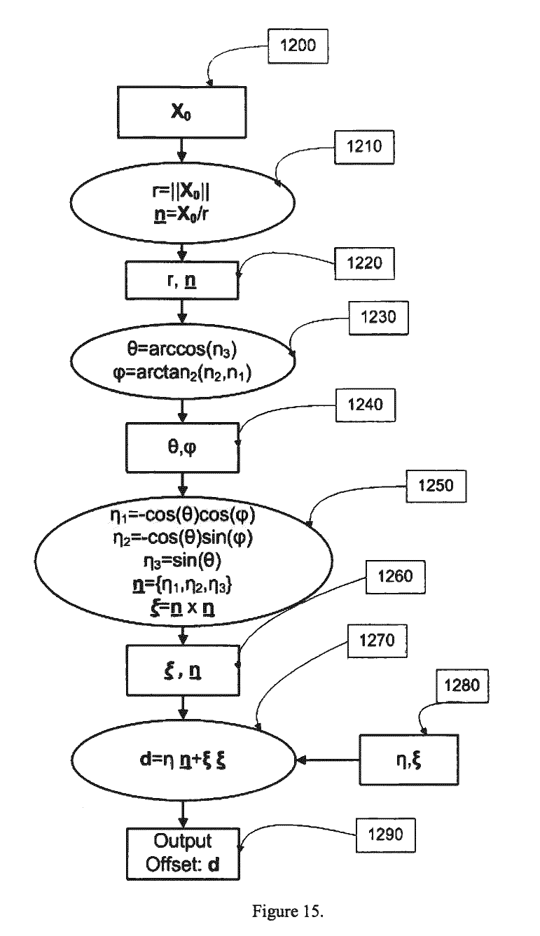

The offset calculation compound of FIG. 14 is described in FIG. 15. The frame origin 1200 is utilized to calculate 1210 the norm 1220 of the vector r=∥Xₒ∥ and the direction

$$\hat{n} = \frac{{X}_{o}}{r}$$

of the input vector Xₒ which is the origin point of the frame. The angles (θ, φ) 1240 corresponding to the direction \hat{n} are then calculated 1230. A subsequent process 1250 calculates the direction of the direction of the frame axis (\hat{ζ}, \hat{η}) 1260. The values are utilized to calculate 1270 the offset vector d in the tracker coordinates and generate an offset output 1290.

### Signal Generation.

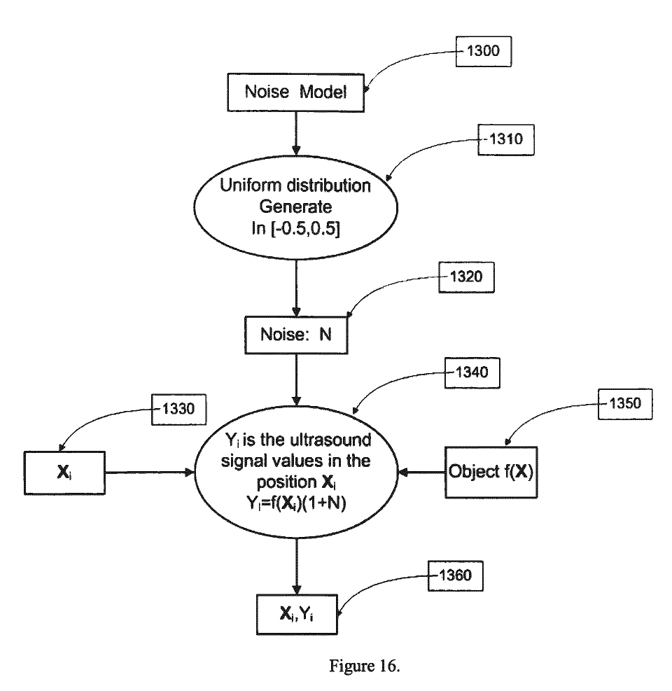

The signal generation compound of FIG. 13 is described in FIG. 16. Initially a Noise Model for example uniform random noises is chosen 1300 and noise 1320 is generated 1310 noise according to this model. The noises are applied to generates the frame video signal. Currently partly multiplication noises and partly addition noises is generated. The multiplication noises is corresponding to ƒ(Xᵢ)N, the addition noises is corresponding to ƒ(Xᵢ)1. Here ƒ(X) is object function. X is the position vector in tracker coordinates. Xᵢ, yᵢ it the output 1360.

### The Diffusion Compound of GPU Implementation.

The compound 0150 in FIG. 6 is described in FIG. 7 in details. The details of GPU implementation are shown in next section. Here we only mention that the compound 0260 is the input compound. 0265 shows the input is copied to GPU device memory. 0270s shows the device memory is divided to many sub-blocks. This data is copied to the compound 0290 of shared memory of GPU. 0208 means the copy is not only done for the corresponding block of device memory, but also all the neighbor blocks are involved. The data in the block is copied to the compound 0300 which is the anisotropic diffusion compound and is shown in details in FIG. 8. The output 0300 is still in the sheared memory of GPU which is 0302. 0304 shows that the image is copied from shared memory to the corresponding sub-region of device memory. 0305 shows the image in sub-region is integrated together in device memory. 0310 shows the output.

VI. The Implementation of the Reconstruction Using GPU.

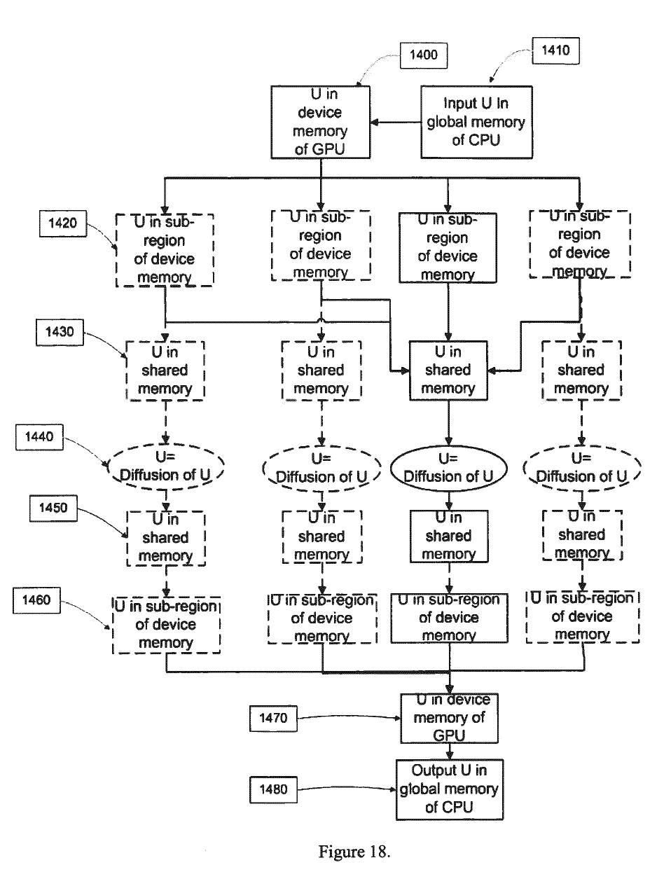

GPU-based speed enhancement technique is applied to the implementation of this invention. Visual C++ compiler is combined with CUDA compiler of nVdia. Here the example of GPU is nVdia. GeForce 8800 GTS Graphic card. The following described the working principle of this invention using a GPU. See generally FIG. 18. The method of the invention is iterative. The iteration consists of a number of loops.

The input image Uₚ^{ML} (created through the compound 0090 in Figure) and kₚ (created through the compound 0110 in FIG. 6) are copied from the host memory of CPU to the device memory of the GPU. By the way, the calculation of Uₚ^{ML} and kₚ can be done in CPU since they are not required any time consuming iterations. However they are also can be calculated using GPU to achieve maximum speed performance.

Create a variable Uₚ in the device memory of GPU. Uₚ is used to save the output image the of a loop of the iteration. Uₚ is also used as input image of the loop of the iteration. Uₚ is initialized to zero at the beginning of the iteration. The count of the iteration is initialized as 0.

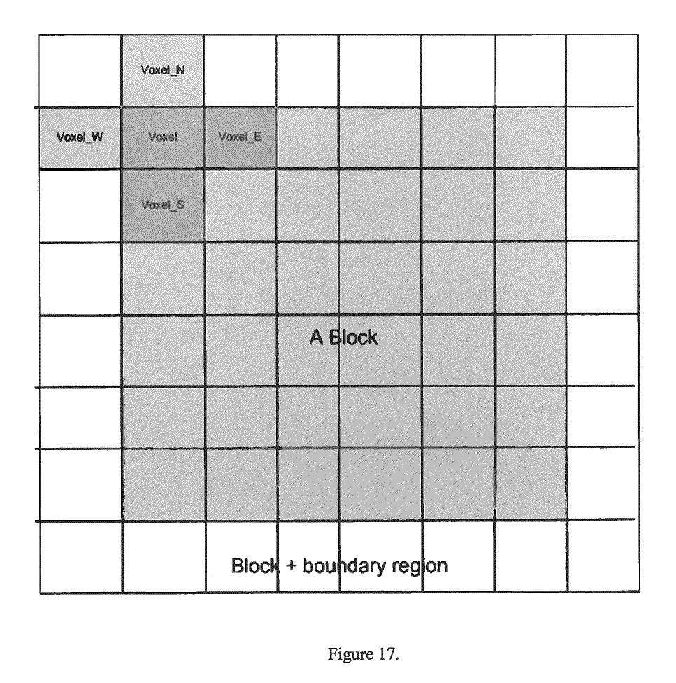

In order to process the 3d image using GPU effectively, the 3D image is divided to a number of blocks or sub-regions see FIG. 17. The image voxels in each block is processed through a thread block in GPU. An overlap is required for this image process to save enough data for a block. Hence a boundary region with one more voxel is required to be considered to the block, see FIG. 17. The output of the voxel is dependent to the value of Voxel_N, Voxel_S, Voxel_E, Voxel_W. Another two elements Voxel_U, Voxel_D are not shown in FIG. 10. From FIG. 10 it can be seen that Voxel_S and Voxel_N are at the boundary region of the block. The values of Voxel_S and Voxel_N have to be taken from the neighbor blocks. If there is no neighbor blocks, the value of Voxel_S and Voxel_N are taken as the same as this Voxel.

Create a variable Uₚ^{sh} in GPU shared memory. The Uₚ^{sh} is a 3 dimensional image see the compound 0290 in FIG. 7. The length of each dimension of the shared memory is equal to the length of the above block in each dimension plus 2. The extra 2 elements is to save the boundary voxels. The values of Uₚ is copied from the shared memory to Uₚ^{sh} in each block. The image voxels of Uₚ^{sh} in the boundary region of the block is copied from Uₚ in the neighbor blocks of that block, this is showed through the lines of 0280 in FIG. 7.

Uₚ^{sh} is inputted to the compound 0300 in the FIG. 7. 0300 is non iterated diffusion compound which is further described in details (see FIG. 8). For each voxel in the block (not include the region of the boundary region) there is a GPU thread to work with it. ∇_{A}U (A=W, E, S, N, L, U) is calculated according the Eq. (36) from Uₚ^{sh}. ∇_{A}U is created through the compound 0210 in FIG. 8. ΔUₚ is calculated according to Eq. (35). ΔU_{P} is shown through the compound 0230 in FIG. 8. c is calculated through Eq. (38).

c is shown through the compound 0220 in FIG. 8. cΔUₚ is calculated through Eq. (37). DUₚ is calculated according Eq. (28). These two steps is realized through the compound 0240 in FIG. 8. The output is sent to the output 0250 which is also the output of the compound 0300 in FIG. 7. All the outputs in the shared memory of different blocks are copied back to the device memory 0305 in FIG. 7. The result is sent to the output 0310 in FIG. 7, which is also the output of the compound 0160 in FIG. 6. From 0305 to 0310 the image Uₚ^{sh} in the shared memory of GPU is copied to device memory of CPU.

Image Uₚ is calculated according to Eq. (27). This is done through the compound 0120, 0160 and 0170 in FIG. 6. The input of the compound 0120 is from 0110. The count of the iteration is increased by 1 in the compound 0170. If the count number larger than the number of iteration the iteration will be stopped. Otherwise Uₚ is further utilized as the input of next loop of the iteration. This is done through the compound 0180 in FIG. 6. In the end, U_{P} is copied from the device memory of GPU to the host memory of CPU as the output.

VII. An Example of Optimization of the Parameters

An example of original object ƒ(X) is a cube, which can be used to produce the simulated ultrasound data. Assume the simulated data is produced according to section I. Assume the number of planes used to cut the 3D object is M=100. The size of one dimension of the image is N=200. The simulated ultrasound data (Xᵢ, Yᵢ) is produce with Eq. (18) or the work flow FIG. 14. In this situation, the image Uₚ^{ML} can be seen in FIG. 4 which is the reconstructed image in the first step. Uₚ^{ML} is the output of the compound 0090 in FIG. 6.

Assuming that t=1.0/7 is taken, the number of iteration N is enough large for example N=1000, the parameters K, K_{d} used in this invention is optimized according to section V with q=0.5 in Eq. (43) where Err is Err₁, Err₂ or Err₁+Err₂. The parameter can be found from Eq. (42). Cubic object is used to produce the simulated ultrasound data. The number of Iteration is taken as 1000. In the beginning k=0.4 is fixed. The calculated result is shown in the following:

TABLE 1
K is fixed at value 0.4, K_{d} is changed. The parameter K_{d} is found at
smallest error Err₁.

| | No | | | | | | |
|---|---|---|---|---|---|---|---|
| | 1 | 2 | 3 | 4 | 5 | 6 | 7 |
| K = | 0.4 | 0.4 | 0.4 | 0.4 | 0.4 | 0.4 | 0.4 |
| K_{d} = | 0.2 | 0.225 | 0.25 | 0.275 | 0.288 | 0.3 | 0.325 |
| Err₁ = | 0.386619 | 0.337024 | 0.335985 | 0.360026 | 0.37945 | 0.403598 | 0.473295 |
| Err₂ = | 1.40846 | 1.10868 | 0.973846 | 0.918293 | 0.904993 | 0.912398 | 1.0089 |
| Err₁ + | 1.795079 | 1.445704 | 1.309831 | 1.278319 | 1.284443 | 1.315996 | 1.482195 |
| Err₂ = | | | | | | | |

The smallest error Err₁ is 0.335985. The corresponding value of parameter K_{d} is 0.25.

TABLE 2
K_{d} is fixed at value 0.25, K is changed. The parameter K is found at
smallest error Err₁.

| | No. | | | | | |
|---|---|---|---|---|---|---|
| | 1 | 2 | 3 | 4 | 5 | 6 |
| K = | 0.8 | 0.6 | 0.4 | 0.3 | 0.25 | 0.2 |
| K_{d} = | 0.25 | 0.25 | 0.25 | 0.25 | 0.25 | 0.25 |
| Err₁ = | 0.382777 | 0.35265 | 0.335985 | 0.346762 | 0.361572 | 0.410167 |
| Err₂ = | 1.33925 | 1.17057 | 0.973846 | 0.876938 | 0.82995 | 0.867875 |
| Err₁ + | 1.722027 | 1.52322 | 1.309831 | 1.2237 | 1.191522 | 1.2780 |
| Err₂ = | | | | | | |

Now we fixed the value of K_{d} as 0.25, the following table shows that the smallest error Err₁ is 0.335985. The corresponding value of parameter K is 0.4. However considering the smallest error of Err₁+Err₂ is 1.191522 and the corresponding value of parameter K is 0.25. A smoother image of reconstruction is corresponding to a smaller K. Since Err₁+Err₂ combining the absolute error and the square error together, it can offer better control of the errors of the image and the smoothness of reconstructed image. Hence in the implementation we use the parameter K=0.25 instead of K=0.4.

After the optimized parameters K=0.25 and K_{d}=0.25 are found. Group parameters which are very close to above parameters are checked. For example Errₛ=0.427283 Err₂=0.90568 if K=0.25 and K_{d}=0.275. These parameters are worse than the parameters K=0.25 and K_{d}=0.25.

In the above, the parameter optimization is done only for one sample of simulated data. This is not justice for the simulation. Different samples of simulated data should be checked. Different object function should be checked. Different M (number of planes) should be used. After a number of tests we have found the parameters are not sensitive to different samples of data, it is also not sensitive to the object function and M. Hence the above optimized parameter can be used generally. It is remarkable if the noise model changed the parameter should be re-adjusted.

VIII. Example of Reconstructions

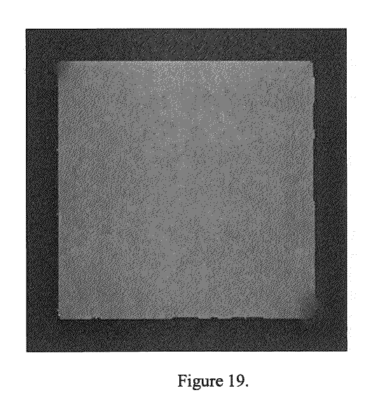

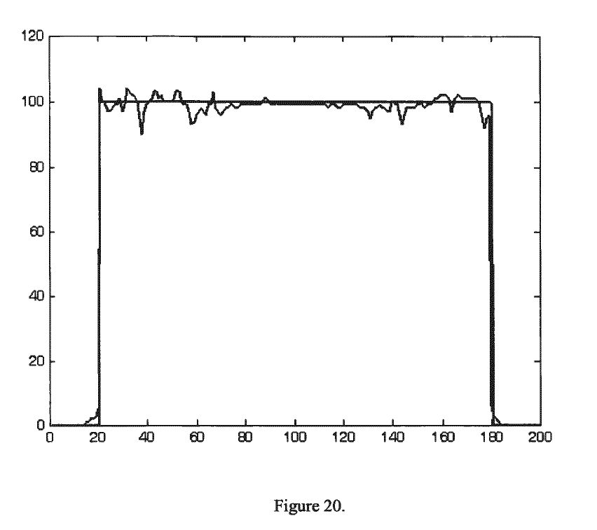

The reconstructed image which is the output of the compound 0190 in FIG. 6 is shown in FIG. 19. Specifically, FIG. 19 shows the reconstructed image of center plane at center plane (k=100) using the algorithm presented in this invention. The number of planes (B-scans) in the simulated data is 100. The image size is 200×200×200. FIG. 20 shows The corresponding profile of the FIG. 19. The profile is cut at i=100. There are two lines: the first one is for the original object and the other is the reconstructed image. The line with an ideal rectangle is corresponding to the original object which is a cube. The other line with small waves inside is corresponding to the reconstructed image. It can be seen that the reconstructed image is quite close to the original object from FIG. 19 and FIG. 20. FIG. 19 and FIG. 20 shows this algorithm is capable offer a smooth reconstructed image with sharp edges.

### ADVANTAGES OF THE CURRENT INVENTION

Comparing to Voxel-based method and Pixel-Based Methods, this invention is based on Function-Based method i.e., the EM method, which has a clear goal function for the minimization. The smoothness of the image and sharpness of the image edge can be combined in this goal function. This invention is not only rigorously interpolation the data but also filtered out noises simultaneously with the iteration of the interpolation.

The image reconstruction method in this invention is ideal for the ultrasound data with freehand scanning. It is extremely suitable to the sparse data which are measured in irregularly positioned B-scan slices.

In this invention the combination of the two error functions the absolute error and the square error for the goal function of the parameter optimization. The combined error function offers the parameters with a good balance for the sharpness or image edge and the smoothness of the image itself.

In this invention there are two parameters K and K_{d} in Eq. (24), (31) and (32) comparing to the EM method which has only one parameters K_{c} in Eq. (25). One more parameter makes the optimization easy to meet the two requirements the sharpness of the image edge and smoothness of the image itself simultaneously.

In the EM method in reference, the sharpness of the image edge and the smoothness of the image are controlled through adapting the variance σ(X), see Eq. (25). In this invention, the sharpness of image edge and smoothness of the image are controlled through the gradient of the image in last loop of the iteration (∇(Uₚ)). Since the variance σ(X) cannot be obtained to a rigorous point, it has to be averaged at a small region, for example within a sphere of radius 5 voxel (around 3×5² voxels). After this average the variance become not sensitive to the edge of image and hence cannot offer big help for the sharpness of image edge. In other hand, the gradient of the image in last iteration (∇(Uₚ)) is rigorous defined at the voxel and its closed 6 neighbor voxels. This information can be utilized to sharp the image edges. Hence this invention obtained better reconstructed image compared to prior EM methods.

FIG. 11(a) shows the absolute errors Err₁ of reconstructed image using different samples of the simulated data. This data is created through Eq. (18). Since the initial seed used to create the pseudo random variable (x₀¹, x₀², x₀³) in Eq. (13) is different for different sample, the simulated data for different sample is also not same. 72 samples of the simulated data are produced. Here the initial seed used in a sample is the last seed of the random number for the prior sample. The number of planes (B-scans) to cut the object is N=100. The object is a rigorous cube which is not shown here. The object can be estimated from the reconstructed image in FIG. 19. The FIG. 11(b) shows the square errors Err₂. Here Err₁ and Err₂ are defined in Eq. (40) and (41). Virtual lines in FIG. 11 are corresponding to the results of the EM method with cubic filter. The solid lines in FIG. 11 are corresponding to the results of this invention. The mean values of Err₁ and Err₂ are given in table 1. All the parameters in the EM method and in this invention are optimized for the first sample. By the way the experiments are shown that the parameters are not sensitive to the samples for these two algorithms. Hence the optimization of them using the first sample is suitable. Table 1 and FIG. 11 shows that this invention obtained smaller absolute errors and square error for the simulated ultrasound data. FIGS. 12 and 13 show the reconstructed image using the EM method in reference. FIGS. 3 and 4 shows the reconstructed image of this invention. The first sample (for which the send is 0) of the simulated ultrasound data are used in the above mentioned image reconstruction. Comparing FIGS. 3,4 to FIGS. 12,13, it can be seen that the reconstructed image in this invention has sharper edge and smoother image.

TABLE 1
The mean values of absolute errors and square errors
of the two algorithms. The number of samples is 10

| | | Err₁ | | Err₂ |
|---|---|---|---|---|
| | Err₁ | (method | Err₂ | (method |
| | (prior EM | in this | (prior EM | in this |
| | method | invention) | method) | invention) |
| Mean | 0.71901 | 0.373568 | 1.615284 | 0.834264 |

In a previous EM method, the sharpness of image edge and smoothness of the image are controlled through adapting K through ∇(Y(X)). Here X is the position and Y is the measured ultrasound value at the position X. ∇(Y(X)) is well defined in the rotatory B-scans. Since in the freehand B-scans, this data X is irregular (sparse or with holes in the space), ∇(Y(X)) is not well defined. This prior method still uses the cubic average which partly reduce sharpness of the image comparing to the anisotropic diffusion filter used in this invention. Hence the method is more restrict to rotatory B-scans. In the method this invention however the sharpness of image edge and smoothness of the image are controlled through ∇(Uₚ), where Uₚ is the output image of last iteration which is well defined to all voxels. ∇(Uₚ) is also well defined.

The implementation of the algorithm is based on CUDA GPU technique, which utilized thousands of real threads in GPU. Hence the speed of calculation is largely increased. In the implementation, the output image voxel is dependent on the neighbor voxels. In GPU there are device memory and shared memory. Shared memory is much fast than device memory however it can be only shared inside a block. In this invention the image in device memory is copied to shared memory. The image is processed in the shared memory. After it finishes the processing, it is copied back to the device memory. This largely reduced the computing time.

1. An interpolation algorithm for iterative application to freehand ultrasound B-scans where the parameters of the algorithm are optimized through the simulation values and positions. and where in a loop of the iteration there are two inputs, the first is the output of image from the last loop of the iteration, the second is the input image before any iteration where the stop of iteration is controlled through the number of iteration which is an adjustable constant, inside a loop of the iteration, we claim:
an image voxel of an output of the above loop that is produced through 2 parts, where
(A) a first part being an input image voxels which is obtained through a simple interpolation and an image is obtained through direct write the 2D pixels to 3D voxels, wherein if there are more pixels in a voxel a weighted average is used to calculate the value of that voxel and wherein if there are no pixels in a voxel a hole is left without any data on this voxel; and
(B) an output of the anisotropic diffusion filter without iteration wherein the input of this filter is the image obtained from the prior loop of the iteration.

2. In claim 1 further includes a parameter which adjusts the weights between the two parts of A and B.

3. In claim 1 further includes another parameter to control the strength of the diffusion filter. This parameter controls the diffusion threshold.

4. The parameters in claims 2 and 3 are optimized through a combined the error function in the freehand ultrasound simulation.

5. In claim 4 the combined error function is consist of two parts. The first part is the absolute error and the second part is the square error. Here the error is defined as the differences between the reconstructed image and the original object used to produce the simulation freehand ultrasound frame data.

6. In claim 1 further comprises that the output of the anisotropic diffusion filter B is a filter which utilized the voxel and its 6 nearest neighbor voxels.

7. In claim 6 further comprises that the output of the anisotropic diffusion filter B is depended on the multiplication of two parts in the following,
a) The first part is the differences between the neighbor voxels described in claim 6 and the voxel.
b) second is a function of the value described in the claim 7 a).

8. The function in the claim 7 b) is further a continuously decreasing positive function that when the input of this function increase from 0 to infinite, the output of the function decreases from 1 to 0 continuously. The example for this kind of function is exp(−x).

9. In claim 6, the input image voxels of the anisotropic filter is initialized to 0 for the first loop of the iteration.

10. In the method of claim 1, the iteration is implemented with the technique of GPU and CUDA. C++ compile is combined with CUDA compile.

11. In the claim 10, the 3D image is saved in the device memory of the GPU, wherein the 3D space of the image is divided as blocks or sub-regions and the GPU shared memory is created to save the image inside the block and wherein the size of the shared memory is equal to the size of the block plus the boundary region and the boundary region is one voxel in each side of the block, wherein the image is copied from the device memory to the shared memory in one loop of iteration for each block, wherein the image part in the boundary region for the shared memory of a block is copied from the device memory of the neighbor blocks of that block, and wherein after the image is processed with a loop of iteration it is copied from shared memory to the device memory of GPU and wherein this process can be repeated as a loop of iteration.
